(19) United States
(12) Patent Application Publication
(10) Pub. No.: US 2026/0039933 A1
(43) Pub. Date: Feb. 5, 2026

(54) TECHNIQUES FOR CONNECTING RELATED INFORMATION AND CREATING CONTENT INCLUDING MEMORY SERVICES

(71) Applicant: Samsung Electronics Co., Ltd., Suwon-si (KR)

(72) Inventors: Dan Philip Gavie, Brooklyn, NY (US); Anthony James Mars, Park Ridge, NJ (US); Rachel Miller, Millbrook, NY (US); Misael Rodriguez Valenzuela, Brooklyn, NY (US); Jamar A. Bromley, Brooklyn, NY (US); Jeewon Lee, Mercer Island, WA (US); Myoung Woo Nam, Yongin (KR); Yeun Wook Lim, Daegu (KR)

(21) Appl. No.: 19/056,034

(22) Filed: Feb. 18, 2025

Related U.S. Application Data
(60) Provisional application No. 63/678,186, filed on Aug. 1, 2024.

(51) Int. Cl. H04N 21/8545

(52) U.S. Cl. CPC H04N 21/8545

(57) ABSTRACT

To provide a memory service, tags are associated with content including photos/videos as well as messages, links, files, call transcripts, payment transaction information, location history, contacts, and/or activity information in an electronic device. Connections are determined between items of the content and photos/videos. A memory is identified as meaningful for a user according to characteristics of a relationship between the user and another person; frequency of communication between the user and the person; content of communication between the user and the person; characteristics of an event or an activity associated with the memory; and characteristics of a location associated with the memory. Digital content aggregated for the meaningful memory includes at least some of the tagged content and at least some of the photos/videos. Based on the aggregated digital content, a digital memory is created allowing the user to reexperience the meaningful memory.

### CROSS-REFERENCE TO RELATED APPLICATION AND PRIORITY CLAIM

This application claims priority under 35 U.S.C. § 119(e) to U.S. Provisional Patent Application No. 63/678,186 filed on Aug. 1, 2024, which is hereby incorporated by reference in its entirety.

### TECHNICAL FIELD

This disclosure relates generally to content tagging, retrieval, and presentation. More specifically, this disclosure relates to techniques for connecting related information and creating content including memory services.

### BACKGROUND

Services such as SAMSUNG Stories (FIG. 12A), GOOGLE Photos (FIG. 12B), and APPLE Memories (FIG. 12C) leverage automatic photo tagging and image recognition in order to group content and create digital memories. By using the Exchangeable Image File Format (EXIF) data and image recognition, these services create connections between photo content to create memories that help users relive past experiences. In addition to automatic photo tagging using EXIF data, users can manually tag content in order for a system to form memories. For example, in some services, users may edit several data points for a photo to manually edit the date and time when the photo was taken, as well as the location where the photo was taken and/or a subject of or keyword associated with the photo.

### SUMMARY

This disclosure relates to techniques for connecting related information and creating content including memory services.

In a first embodiment, a method includes associating, using at least one processing device of an electronic device, tags with content including two or more of: messages, links, files, call transcripts, payment transaction information, location history, contacts, or activity information in the electronic device. The method also includes determining, using the at least one processing device, connections between items of the content and connections of the items of the content with photos or videos in the electronic device. The method further includes identifying, using the at least one processing device, a memory as meaningful for a user of the electronic device based on at least some of the determined connections. The memory is identified as meaningful based on at least one of: one or more characteristics of a relationship between the user and a person corresponding to one of the contacts that is associated with the memory; a frequency of communication between the user and the person; content of the communication between the user and the person; one or more characteristics of an event or an activity associated with the memory; and one or more characteristics of a location associated with the memory. The method also includes aggregating, using the at least one processing device, digital content for the memory, where the aggregated digital content includes at least some of the tagged content associated with the memory and at least some of the photos or videos associated with the memory. In addition, the method includes creating, using the at least one processing device, a digital memory based on at least some of the aggregated digital content. The digital memory allows the user to reexperience the memory. The digital memory includes at least a portion of the tagged content within the aggregated digital content and at least a portion of the photos or videos within the aggregated digital content.

In a second embodiment, an electronic device includes at least one processing device configured to associate tags with content including two or more of: messages, links, files, call transcripts, payment transaction information, location history, contacts, or activity information in the electronic device. The at least one processing device is also configured to determine connections between items of the content and connections of the items of the content with photos or videos in the electronic device. The at least one processing device is further configured to identify a memory as meaningful for a user of the electronic device based on at least some of the determined connections. The at least one processing device is configured to identify the memory as meaningful based on at least one of: one or more characteristics of a relationship between the user and a person corresponding to one of the contacts that is associated with the memory; a frequency of communication between the user and the person; content of the communication between the user and the person; one or more characteristics of an event or an activity associated with the memory; and one or more characteristics of a location associated with the memory. The at least one processing device is also configured to aggregate digital content for the memory, where the aggregated digital content includes at least some of the tagged content associated with the memory and at least some of the photos or videos associated with the memory. In addition, the at least one processing device is configured to create a digital memory based on at least some of the aggregated digital content. The digital memory includes at least a portion of the tagged content within the aggregated digital content and at least a portion of the photos or videos within the aggregated digital content.

In a third embodiment, a non-transitory machine readable medium contains instructions that when executed cause at least one processor of an electronic device to associate tags with content including two or more of: messages, links, files, call transcripts, payment transaction information, location history, contacts, or activity information in the electronic device. The instructions when executed also cause the at least one processor to determine connections between items of the content and connections of the items of the content with photos or videos in the electronic device. The instructions when executed further cause the at least one processor to identify a memory as meaningful for a user of the electronic device based on at least some of the determined connections. The instructions when executed cause the at least one processor to identify the memory as meaningful based on at least one of: one or more characteristics of a relationship between the user and a person corresponding to one of the contacts that is associated with the memory; a frequency of communication between the user and the person; content of the communication between the user and the person; one or more characteristics of an event or an activity associated with the memory; and one or more characteristics of a location associated with the memory. The instructions when executed also cause the at least one processor to aggregate digital content for the memory, where the aggregated digital content includes at least some of the tagged content associated with the memory and at least some of the photos or videos associated with the memory. In addition, the instructions when executed cause the at least one processor to create a digital memory based on at least some of the aggregated digital content. The digital memory allows the user to reexperience the memory. The digital memory includes at least a portion of the tagged content within the aggregated digital content and at least a portion of the photos or videos within the aggregated digital content.

Any one or any combination of the following features may be used with the first, second, or third embodiment. The memory may be identified as meaningful according to an estimation of emotional weight or significance of the memory to the user. The digital memory may include a representative photo or video associated with the memory; a title and a description for the digital memory, where each of the title and the description may be based on at least part of the aggregated digital content; and one or more branches for different aspects of the digital memory. The different aspects of the digital memory may include two or more of: timing, location, user activity, and one or more recommendations based on at least a portion of the aggregated digital content. The digital memory may include one or more additional photos or videos associated with the memory in addition to the representative photo or video. The digital memory may be created in response to at least one of: one or more keywords in a user search on the electronic device; content in a message composed by the user on the electronic device; or a current activity of the user. A detail view for the digital memory may be generated, one or more branches from the detail view may be generated for the digital memory, and an access link to the digital memory may be displayed on the electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for collecting and connecting information to create memory stream content in accordance with this disclosure;

FIG. 2 illustrates an example process of collecting and connecting information to create memory stream content in accordance with this disclosure;

FIG. 3 illustrates an example structure for a memory stream system that collects and connects information to create memory stream content for meaningful memories in accordance with this disclosure;

FIG. 4 illustrates an example process of manually determining the relationship of a user to a contact saved on the user's device in accordance with this disclosure;

FIGS. 5A through 5C illustrate an example process of automatically determining a user's relationship to a person represented by a contact in the user's electronic device in accordance with this disclosure;

FIG. 6 illustrates examples of different types of memorable events for which a user memory content grouping can be generated in accordance with this disclosure;

FIGS. 7A through 7C illustrate example user interface displays showing various triggers for surfacing a meaningful memory to the user of the electronic device in accordance with this disclosure;

FIG. 8 illustrates an example set of user interface displays and associated actions illustrating manners by which a meaningful memory may be surfaced to or accessed by the user of the electronic device in accordance with this disclosure;

FIGS. 9A through 9C illustrate example user interface displays showing various examples of meaningful memories that can be aggregated and displayed by the memory stream using content locally stored on the user's electronic device in accordance with this disclosure;

FIGS. 10A through 10D illustrate one example scenario for operation of the memory stream system in accordance with this disclosure;

FIGS. 11A through 11F illustrate another example scenario for operation of the memory stream system in accordance with this disclosure; and

FIGS. 12A through 12C illustrate example user interfaces from various memory services.

### DETAILED DESCRIPTION

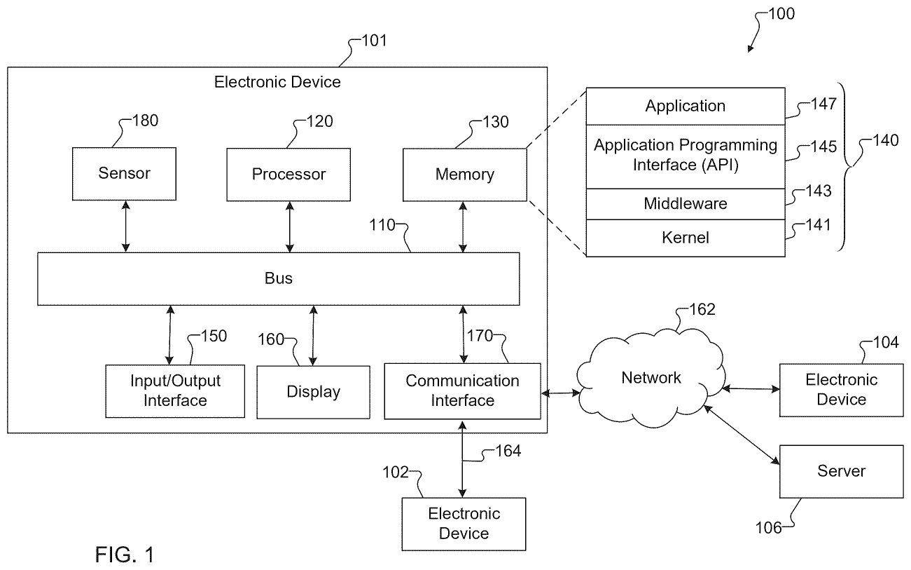

FIGS. 1 through 11F, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

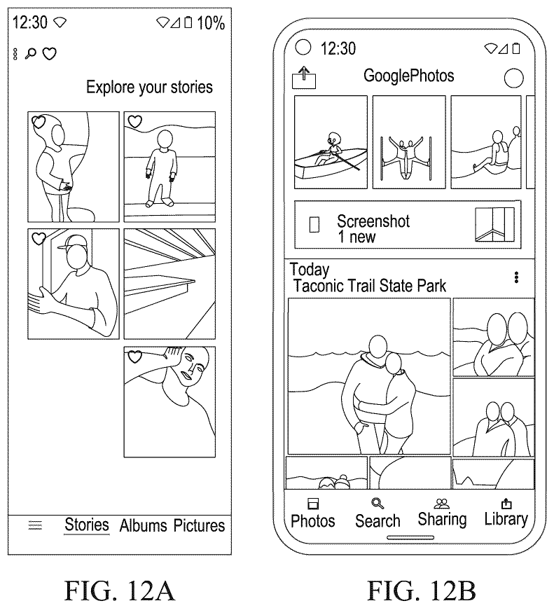

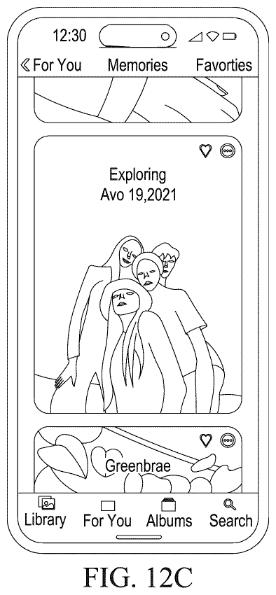

As noted above, services such as SAMSUNG Stories (FIG. 12A), GOOGLE Photos (FIG. 12B), and APPLE Memories (FIG. 12C) leverage automatic photo tagging and image recognition in order to group content and create digital memories. By using the Exchangeable Image File Format (EXIF) data and image recognition, these services create connections between photo content to create memories that help users relive past experiences. In addition to automatic photo tagging using EXIF data, users can manually tag content in order for a system to form memories. For example, in some services, users may edit several data points for a photo to manually edit the date and time when the photo was taken, as well as the location where the photo was taken and/or a subject of or keyword associated with the photo.

Existing services often leverage content available for a specific digital service or product to allow users to relive memories. For example, photo memories are created by leveraging both automatically- and manually-generated metadata associated with photos. However, the services are limited to photos and videos and do not leverage metadata across multiple different types of content (such as messages, transcribed calls, payments, links, and files) to create more emotional, fuller memories for people to relive. Further, automatic metadata creation lacks the requisite criteria and does not have access to enough information to create meaningful combinations of different types of contents.

This disclosure provides various techniques for connecting related information and creating content including memory services. In the present disclosure, data is collected and connected for use in presenting multimedia memories that improve the user experience for remembering and reliving meaningful memories. In order to provide a good experience to users for reliving memories with more emotion, a resource for sharing key details or information tied to a memory with other parties (such as restaurant recommendations or reviews for a trip) can be provided.

FIG. 1 illustrates an example network configuration 100 that may be employed for collecting and connecting information to create memory stream content in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to collecting and connecting information to create memory stream content.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to collecting and connecting information to create memory stream content. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101. In some embodiments, the sensor(s) 180 include at least one camera or other imaging sensor that captures a burst of images, and the electronic device 101 can perform image alignment of two or more images within the captured burst as described in further detail below.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to collecting and connecting information to create memory stream content.

Although FIG. 1 illustrates one example of a network configuration 100 including an electronic device 101 employed for collecting and connecting information to create memory stream content, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

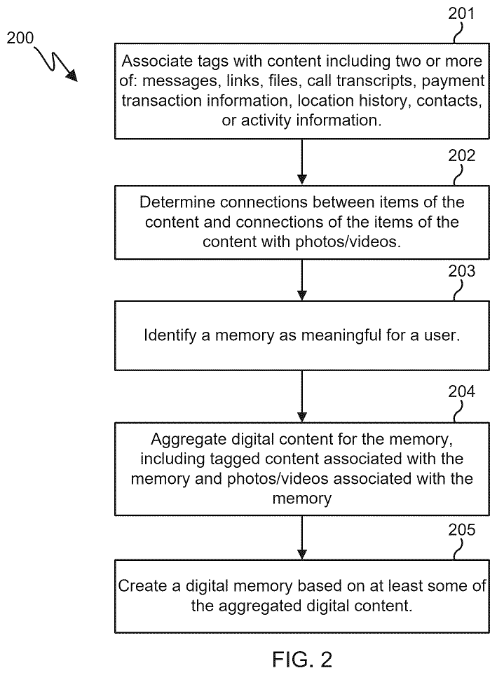

FIG. 2 illustrates an example process 200 of collecting and connecting information to create memory stream content in accordance with this disclosure. For case of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 begins with associating, using at least one processing device of an electronic device, tags with content including two or more of: messages, links, files, call transcripts, payment transaction information, location history, contacts, or activity information (such as hiking, biking, etc.) in the electronic device (step 201). The tagged content also includes photos/videos. A non-limiting example of the different content types that are tagged in this operation is described below in connection with TABLE 1. A non-limiting example of the tags is described below in connection with TABLE 2.

Connections between items of the content and connections of the items of the content with photos or videos are determined (step 202) to identify memories. In some cases, overlap in time, location, people, and/or activity can be employed to determine connections. Based on the determined connections, a memory is identified as meaningful for a user of the electronic device (step 203). The memory can be identified as meaningful based on various factors, such as at least one of: one or more characteristics of a relationship (such as formal, informal or friendly, or close friend or family) between the user and a person corresponding to a contact is associated with the memory; a frequency of communication (such as frequent versus infrequent) between the user and the person; content of the communication between the user and the person (using semantics, diction, and emotive expression as discussed in further detail below); one or more characteristics of an event or an activity associated with the memory (such as daily, recurring, or unique; thematic); and one or more characteristics of a location associated with the memory (such as a landmark, overseas, home, work, etc.). The memory may be identified as meaningful according to an estimation of emotional weight or significance of the memory to the user as discussed below. The estimation of emotional weight or significance may be relative, meaning one memory may be estimated to have more emotional weight or significance than other memories.

Digital content is aggregated for the memory (step 204). The aggregated digital content can include at least some of the tagged content (such as photos/videos, messages, links, files, call transcripts, payment transaction information, location history, contacts, or activity information as noted above) associated with the memory. A digital memory is created based on at least some of the aggregated digital content (step 205). The digital memory allows the user to reexperience the memory and can include photos/videos as well as, for example, location or activity information allowing for more emotional and fuller memories.

Although FIG. 2 illustrates one example of a process 200 of collecting and connecting information to create memory stream content, various changes may be made to FIG. 2. For example, while shown as a series of steps, various steps in FIG. 2 could overlap, occur in parallel, occur in a different order, or occur any number of times (including zero times).

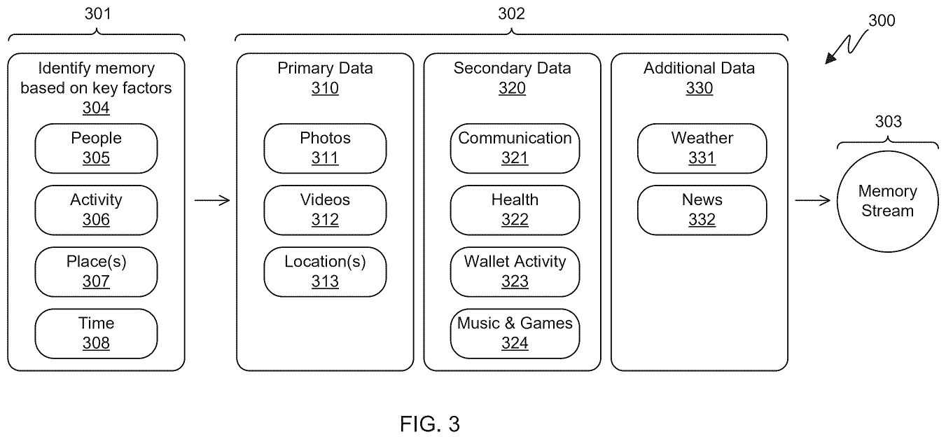

FIG. 3 illustrates an example structure for a memory stream system 300 that collects and connects information to create memory stream content for meaningful memories in accordance with this disclosure. For case of explanation, the memory stream system 300 of FIG. 3 is described as being implemented using the electronic device 101 in the network configuration 100 of FIG. 1. However, the memory stream system 300 may be implemented using any other suitable device(s) and in any other suitable system(s).

The memory stream system 300 is composed of three core components, namely a tagging content system 301, a relationship system 302 for understanding relationships with (for example) contacts and how the contacts relate to contents and events, and memory stream generation 303. The memory stream system 300 generally operates to aggregate multiple different content types (such as photos, videos, messages, transcribed calls, payments, locations, and contacts) in order to generate memories for people. The memory stream system 300 can use tagging of these different types of contents to determine what content goes into the creation of a memory. The above-identified types of content can be associated with certain stored metadata, such as the following types of metadata.
Photos: date, seasonal event, time, location, weather, object, contact
Videos: date, seasonal event, time, location, weather, object, contact, duration
Messages: date, seasonal event, time, contact, communication sentiment, communication frequency
Links/files: date, seasonal event, time, contact, communication sentiment, communication frequency
Transcribed calls: date, seasonal event, time, call duration, contact, communication sentiment, communication frequency
Payment: date, time, location, weather, seasonal event, transaction amount, merchant
Location: photos, payments, contacts, location frequency
Contact: last interaction, message frequency, call frequency, relationship, number of photos, number of videos.
   TABLE 1 provides one example of how content may be categorized.

TABLE 1

| Content | Content | Content | Content | | Content |
|---|---|---|---|---|---|
| Type | Name | Name | Name | | Name |
| PHOTOS | Photo 1 | Photo 2 | Photo 3 | . . . | Photo X |
| VIDEOS | Video 1 | Video 2 | Video 3 | . . . | Video X |
| MESSAGES | Message 1 | Message 2 | Message 3 | . . . | Message X |
| LINKS & | Link/ | Link/ | Link/ | . . . | Link/ |
| FILES | File 1 | File 2 | File 3 | | File X |
| CALLS | Call | Call | Call | . . . | Call |
| (Voice & | transcript | transcript | transcript | | transcript |
| Video) | 1 | 2 | 3 | | X |
| PAYMENT | Payment 1 | Payment 2 | Payment 3 | . . . | Payment X |
| LOCATION | Location 1 | Location 2 | Location 3 | . . . | Location X |
| CONTACT | Contact 1 | Contact 2 | Contact 3 | . . . | Contact X |

The memory stream system 300 can use metadata associated with local content to form connections between different items of content and to enable the memory stream system 300 to aggregate memories with different types of content.

The tagging content system 301 identifies a (user) memory based on various factors. Four example factors are depicted in FIG. 3, namely people 305, activities 306, places/locations 307, and time 308. Based on such factors, the tagging content system 301 can employ metadata to tag content. One example of content tagging is provided in TABLE 2.

TABLE 2

| Metadata Tag | Photo 1 | Photo 2 | Photo 3 | |
|---|---|---|---|---|
| Date | Oct. 6, 2023 | Aug. 16, 2023 | Aug. 16, 2023 | . . . |
| Time | 11:00-18:00 | 14:38 | 14:43 | . . . |
| Season | Autumn | Summer | Summer | . . . |
| Location | Shandaken, NY 12464 | Rockaway, NY 11693 | Rockaway, NY 11693 | . . . |
| Weather | Blue skies | Sunny | Sunny | . . . |
| Object recognition | Hiking | Beach | Beach | . . . |
| Contact | Jane Doe | John Doe | John Doe | . . . |
| Event | Hiking in Catskill | A day at the beach | A day at the beach | . . . |
| | Mountains | | | |
| Duration | N/A | N/A | N/A | . . . |
| Communication sentiment | Friendly | N/A | N/A | . . . |
| Communication frequency | Frequent | Frequent | Frequent | . . . |
| Transaction amount | N/A | N/A | N/A | . . . |
| Merchant or vendor | N/A | N/A | N/A | . . . |
| Payment amount | N/A | N/A | N/A | . . . |
| Frequency | Infrequent | Frequent | Frequent | . . . |
| Relationship | Close contact | Close contact | Close contact | |
| Number of contents shared | 387 | 43 | 43 | . . . |

The relationship system 302 can classify data at a variety of levels. In the example of FIG. 3, the levels include primary data 310, secondary data 320, and additional data 330. In this particular example, the primary data 310 includes photos 311, videos 312, and location(s) 313; the secondary data 320 includes communication(s) 321, health information 322, wallet activity 323, and music and games 324; and the additional data 330 includes weather 331 and news 332. The memory stream system 300 can use tagged data that is created or accessed on the user's device as ingredients or building blocks to generate meaningful memories for the user to re-experience. “Meaningful” is defined herein as content having an emotional weight or significance as determined for the user through active tracking of the user's patterns or frequency of behavior and a user's relationship to other parties. In some cases, relationships to other parties, or relationships in general, can be manually defined by the user by editing profile data found in contacts, such as when relationships are categorized as spouse, significant other, acquaintance, close friend, or family member (brother/sister/sibling, parent, grandparent, aunt/uncle, cousin, niece/nephew, etc.).

Although FIG. 3 illustrates one example of a memory stream system 300 that collects and connects information to create memory stream content for meaningful memories, various changes may be made to FIG. 3. For example, components can be added, omitted, combined, further subdivided, replicated, or placed in any other suitable configuration in the system 300 of FIG. 3 according to particular needs.

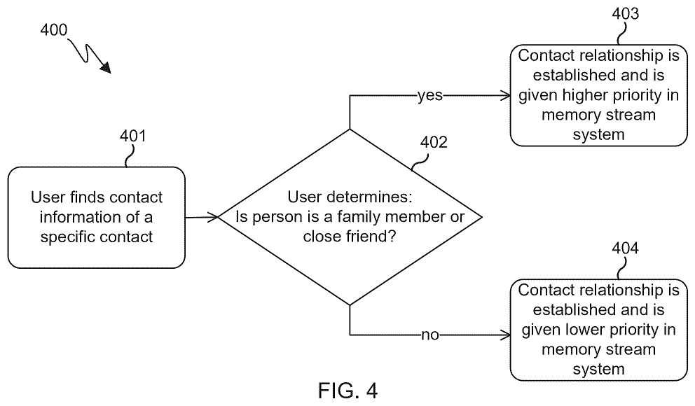

FIG. 4 illustrates an example process 400 of manually determining the relationship of a user to a contact saved on the user's device in accordance with this disclosure. For case of explanation, the process 400 of FIG. 4 is described as being performed using the electronic device 101 in the network configuration 100 of FIG. 1 as part of the operation of the memory stream system 300 in FIG. 3. However, the process 400 may be performed using any other suitable device(s) and in any other suitable system(s).

As shown in FIG. 4, the process 400 begins with a user finding a specific contact within the user's electronic device (step 401). A determination is made (step 402) whether the person represented by the contact is a family member or close friend. If so, the corresponding relationship (family member or close friend) is established within the contact in the user's electronic device (step 403), and the contact is given higher priority by the memory stream system 300. If not, a “normal” relationship (indicating absence of a close relationship) may be established within the contact in the user's electronic device (step 404), and the contact is given lower priority by the memory stream system 300. Within the hierarchy of relationships to the user, the user may designate more specific categories such as “significant other,” “parent,” “sibling,” child,” etc.

Although FIG. 4 illustrates one example of a process 400 of manually determining the relationship of a user to a contact saved on the user's device, various changes may be made to FIG. 4. For example, while shown as a series of steps, various steps in FIG. 4 could overlap, occur in parallel, occur in a different order, or occur any number of times (including zero times). Also,

In other embodiments, machine learning (ML), artificial intelligence (AI), or other functionality can automatically determine the user's relationship with another party represented by a contact in the user's electronic device. In some cases, this can be done by analyzing the pattern and frequency of communication the user has with the other party, understanding the emotional value of that communication by analyzing the semantics, diction, and/or emotive expression used in communication, etc.

“Semantics” relates to the meaning behind word usage, such as when “I love you” would signify a certain relationship with another party on the level of a significant other, best friend, or spouse. As another example, statements like “Dad doesn't want us to do that” would signify a sibling relationship.

“Diction” relates to word usage in communication, such as when “gnarly” or “ngl” would signify an informal (friendly) relationship due to the use of slang or common Internet abbreviations, and therefore a relationship more akin to friendship. On the other hand, “Let's determine a time and place to meet” would signify a more formal relationship due to the stiffness of the chosen diction. However, cultural/dialectical/idiomatic expressions, which relate to semantic and diction communication associated with regional or ethnic expression (such as Southern American English or African American English), can also be taken into account. The system can have awareness of these expressions and forms of speech in order to avoid incorrectly identifying a relationship as friendly due to the diction used, which may appear to be playful slang on the surface but which may very well be a contentious communication.

“Emotive expression” relates to the use of special effects like typographical emphasis or use of exaggeration/superlatives to express emotions (such as anger, joy, fright). Similarly, use of emojis and GIFs or images (like reaction-based images, such as those that involve a character, actor, or public figure with a unique or particularly emotive facial or gestural expression) display an emotion that may be difficult to describe in text and is indicative of a more informal relationship between two parties.

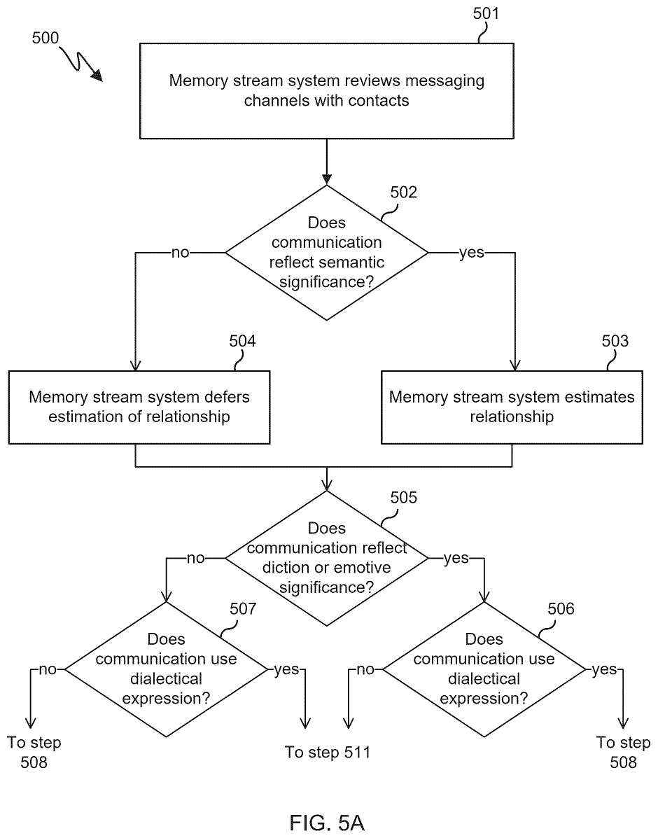

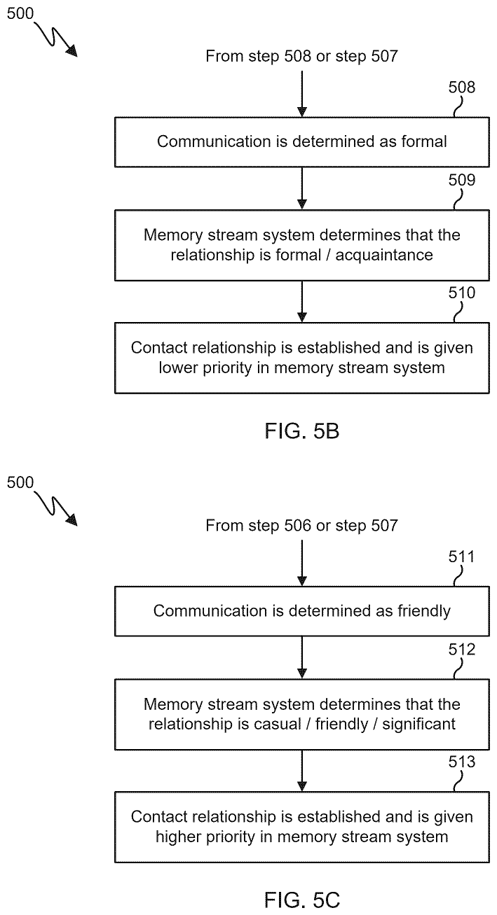

FIGS. 5A through 5C illustrate an example process 500 of automatically determining a user's relationship to a person represented by a contact in the user's electronic device in accordance with this disclosure. For case of explanation, the process 500 of FIGS. 5A through 5C is described as being performed using the electronic device 101 in the network configuration 100 of FIG. 1 as part of the operation of the memory stream system 300 in FIG. 3. However, the process 500 may be performed using any other suitable device(s) and in any other suitable system(s).

As shown in FIG. 5A, the process 500 begins with the memory stream system 300 reviewing one or more communications between the user of the electronic device and a specific contact in the user's electronic device (step 501). A determination is made as to whether the one or more communications reflect semantic significance (step 502). If so, the memory stream system estimates a relationship between the user of the electronic device and the person represented by the contact (step 503). In some cases, the estimation may merely represent an initial characterization of the relationship and may be subsequently revised. If the one or more communications do not reflect semantic significance, the memory stream system defers estimation of the relationship (step 504).

The process proceeds, from either step 503 or step 504, to evaluation of the diction of the communication(s) and whether the communication(s) may reflect emotive significance (step 505). The diction used in the communication(s) or any emotive expression therein may indicate a relationship is either that of a close friend or a significant relationship or of a more formal relationship. Regardless of the outcome of the determination in step 505, a determination is made whether the communication(s) may use dialectical expression (steps 506 and 507). As noted above, use of dialectical expression may negate any inference regarding the significance of the relationship.

Based on the outcomes of the determinations in steps 505-507, the process proceeds to either step 508 or step 511. If the diction and emotive significance of the user's communication(s) with person represented by a contact suggest a formal relationship and dialectical expression is not used, the communication(s) can be identified as formal (step 508). The memory stream system therefor determines the relationship to be formal (or at most, that of a mere social acquaintance) (step 509). The contact relationship is established in the memory stream system, and the contact is given a lower priority (among the tiers or levels of priorities used) in the memory stream system (step 510). On the other hand, if the diction and emotive significance of the user's communication(s) with person represented by a contact suggest a close relationship (significant other, family, close friend) and dialectical expression is not used, the communication is determined as friendly (step 511). The memory stream system determines the relationship to be friendly (step 512), and the contact relationship is established in the memory stream system and the contact is given a higher priority (among the tiers or levels of priorities used) in the memory stream system (step 513).

Although FIGS. 5A through 5C illustrate one example of a process 500 of automatically determining a user's relationship to a person represented by a contact in the user's electronic device, various changes may be made to FIGS. 5A through 5C. For example, while shown as a series of steps, various steps in FIGS. 5A through 5C could overlap, occur in parallel, occur in a different order, or occur any number of times (including zero times).

Once a relationship is determined and categorized, the memory stream system 300 may tag incoming and on-device generated data/media based on that relationship to build stronger memories. While tagging occurs, the memory stream system 300 may attempt to make sense of significant milestones or events in the user's life. These events are usually (but not always) tied to a pattern or to unique events. In some cases, events may be categorized into multiple tiers, such as the following three tiers.

“Daily/frequent” events are events that happen in a consistent pattern throughout the year with one or more consistent variables. The consistent variables may include (1) time and date—that is, the actual time this event occurs (such as every other Friday at 8:00 pm); (2) the activity—that is, the type of activity that occurs, such as hiking, bouldering, etc. (note that an example of a primarily digital activity or experience could be video calling a friend); and/or (3) location—that is, the geospatial positioning determined by cross referencing GPS and Wi-fi technologies and Internet data resources like a map application to pinpoint the location of the user (such as at “Brooklyn Boulders”). Note, however, that any other suitable characteristics may be used for times/dates, activities, and locations. The conditions for surfacing a memory classified as a daily event may be, for example, the end of the month, year, or other specified period of time or when the user specifically queries the memory.

“Unique” events are events that happen inconsistently, erratically, or only once. The variables that determine such an event may include (1) time and date—that is, the event happened once or a limited number of times (such as a wedding ceremony); (2) activity—that is, the type of activity that occurred (such as sky diving); and/or (3) location—that is, when a completely new geospatial positioning has been registered for the first time (such as going on vacation to a country never visited before). The conditions for surfacing a memory classified as a unique event may be, for example, after the event comes to an end and/or at the end of each day during the event.

“Thematic” events are events determined to be recurring based on (1) time and date—that is, the event happens in predetermined intervals according to natural or cultural norms (such as moon cycles/seasons, national holidays or celebrations such as Halloween or Independence Day); and/or (2) activity—that is, the events are of the same activity but may be aggregated from different relationships (such as a collection of weddings attended during a calendar year). The conditions for surfacing a memory classified as a thematic event may be, for example, before the anticipated event occurs.

Memory stream generation 303 occurs after an event tag is created. For example, when the tag “Trip to Greece Summer 2023” is created, the memory stream system 300 can tag all content related to that event and group that content into a user memory. This process of grouping related content may be repeated to further subdivide and group the content into branches or subcategories within the user memory. In some cases, branches can be as simple as Day 1, 2, 3, etc. of the trip. Content within the branches can be grouped, such as by overlapping time and date. The memory stream system 300 can repeat this process within a branch, further grouping content that is closely related in time (such as images taken at 3:00 pm, messages received within a ±5 minute buffer around 3:00 pm, music listened during the 3:00 pm timeframe, etc.).

One example of content grouping for a user memory is provided in TABLE 3.

TABLE 3

| Metadata Tag | Photo 1 | Video 1 | Message 1 | |
|---|---|---|---|---|
| Date | Oct. 6, 2023 | Oct. 6, 2023 | Oct. 6, 2023 | . . . |
| Time | 11:00-18:00 | 11:00-18:00 | 11:00-18:00 | . . . |
| Season | Autumn | Autumn | Autumn | . . . |
| Location | Shandaken, NY 12464 | Shandaken, NY 12464 | Brooklyn, NY 11213 | . . . |
| Weather | Blue skies | Blue skies | Clear skies | . . . |
| Object recognition | Hiking | Hiking | Communication | . . . |
| Contact | Jane Doe | Jane Doe | Jane Doe | . . . |
| Event | Hiking in Catskill | Hiking in Catskill | Hiking in Catskill | . . . |
| | Mountains | Mountains | Mountains | |
| Duration | N/A | 1:08 | N/A | . . . |
| Communication sentiment | Friendly | Friendly | Friendly | . . . |
| Communication frequency | Frequent | Frequent | Frequent | . . . |
| Transaction amount | N/A | N/A | N/A | . . . |
| Merchant or vendor | N/A | N/A | N/A | . . . |
| Payment amount | N/A | N/A | N/A | . . . |
| Relationship | Close contact | Close contact | Close contact | |
| Number of contents shared | 387 | 387 | 387 | . . . |

The above example illustrates how content may be connected when searching for a “Hiking with Samantha” user memory content grouping.

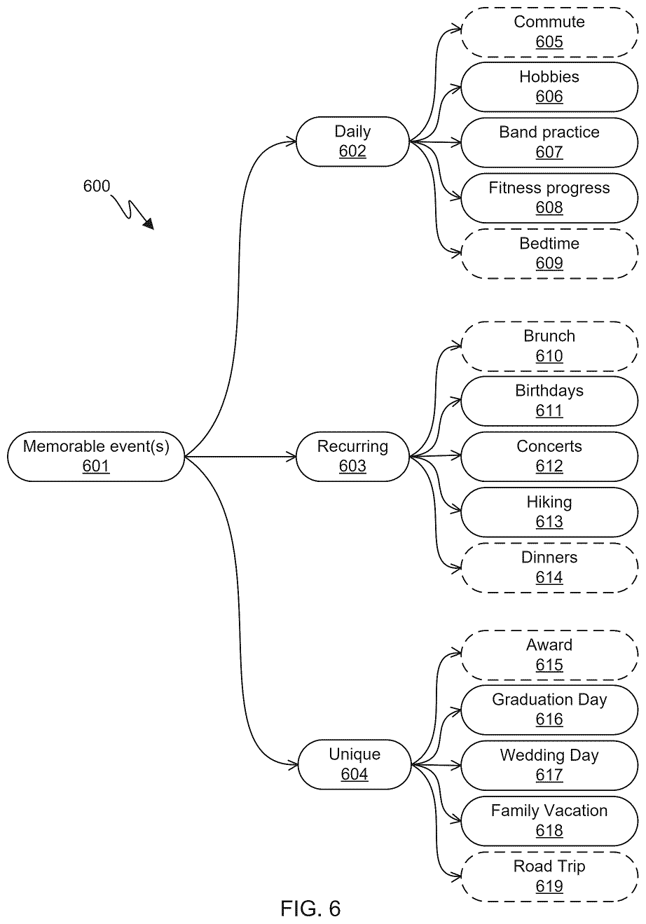

FIG. 6 illustrates examples of different types of memorable events for which a user memory content grouping can be generated in accordance with this disclosure. In the examples 600 of FIG. 6, meaningful memory events may be classified based on frequency, such as daily events 601, recurring events 602, or unique events 603. As illustrated using dashed lines, some events in each category may not warrant formation of a user memory content grouping. For instance, among daily events 602 (which in the examples shown includes a daily commute 605, time spent on the user's hobbies 606, time spent at band practice 607, time spent on physical fitness 608, and the user's bedtime routine 609), the events corresponding to the user's daily commute and the user's bedtime routine are unlikely to involve meaningful memories. It should be noted that events such as daily time spent on the user's hobbies 606 or time spent on physical fitness 608 may have significance that manifests over time, such as completion of a project or achievement of a fitness goal or athletic challenge.

When potentially meaningful memory events are initially filtered by one characteristic, a second attribute may further filter the significance of the memory to the user. For example, among recurring events 603 (which in the examples shown includes brunches 610, birthdays 611, concerts 612, hiking 613, and dinners 614), significance or emotional weight may be ascribed to the type of event. Birthdays 611, concerts 612, and hiking 613 are examples of event types that are more likely to hold significance or emotional weight for the user. Similarly, even among unique events 604 (which in the examples shown includes awards 615, graduation day 616, wedding day 617, family vacation 618, and road trip 619), graduations, weddings, and vacations may be considered more likely to hold significance or emotional weight for the user than awards or trips involving (for example) work or family visits.

Although FIG. 6 illustrates examples of meaningful memory events for which a user memory content grouping can be generated, various changes may be made to FIG. 6. For example, while time-based categories (frequency as one of daily/recurring/unique) are illustrated, other attributes (such as significance of relationship to a contact or user location) may be employed in identifying potentially meaningful memories.

The memory stream generation 303 may surface meaningful memories to the user based on any one or more of a variety of factors. For example, when a trigger is received or activated, the memory stream system 300 may determine appropriate content to surface by cross-referencing the event tag with the incoming trigger. For example, if the user searches for “Trips to Greece” in a search function or types “I went to Greece that year” in a message thread, the memory stream system 300 may surface the “Trip to Greece Summer 2023” user memory as a result. Later in the year, or in the next year close to the one-year anniversary, the memory stream system 300 may surface the “Trip to Greece Summer 2023” user memory as a notification on the electronic device to the user.

The system need not be solely retrospective but can also generate a memory stream in real-time without a user request. For example, when the system creates an event tag such as “Camille's graduation day,” the event can be determined as immediately meaningful, and the memory stream system 300 can build out the user memory content grouping in real-time as additional content is generated and associated in the manner described above.

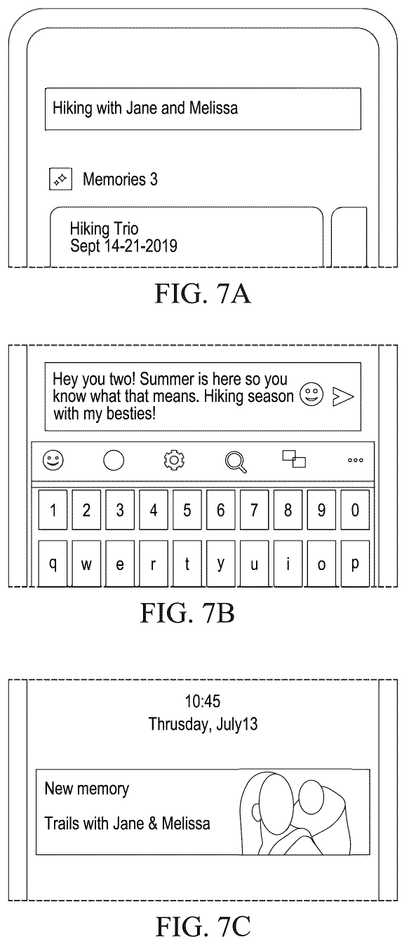

FIGS. 7A through 7C illustrate example user interface displays showing various triggers for surfacing a meaningful memory to the user of the electronic device in accordance with this disclosure. There may be multiple paths into the memory stream generation 303 that can result in a meaningful memory being surfaced to the user. For example, FIG. 7A illustrates a search path in which the user manually inputs keywords into the search function of the electronic device, seeking results in a goal-oriented manner. FIG. 7B illustrates a keyboard path in which word or intent recognition applied to text that is input by the user into an application with discoverability to the memory stream system 300 (such as while composing a message) surfaces a meaningful memory that is served to the user. FIG. 7C illustrates an activity path in which a notification that is contextual with the user's current activity serves as an entry for a (such as shared) memory and is presented at relevant moments.

Although FIGS. 7A through 7C illustrate examples of user interface displays showing various triggers for surfacing a meaningful memory to the user of the electronic device, various changes may be made to FIGS. 7A through 7C. For example, launch of specific apps (such as social media, fitness monitoring, or payment) or interaction with specific contacts may initiate surfacing of a meaningful memory to a user.

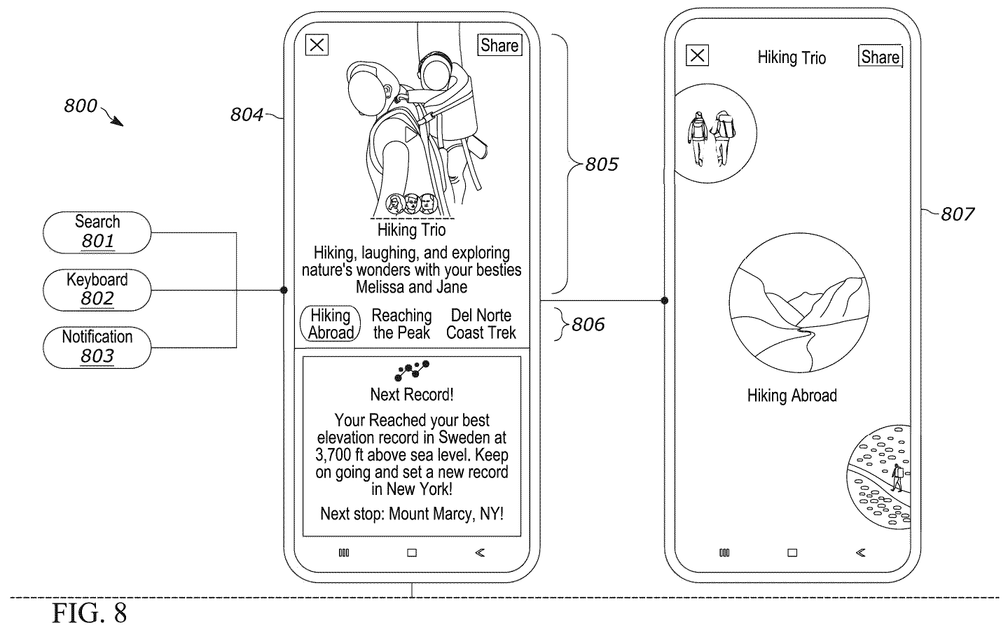

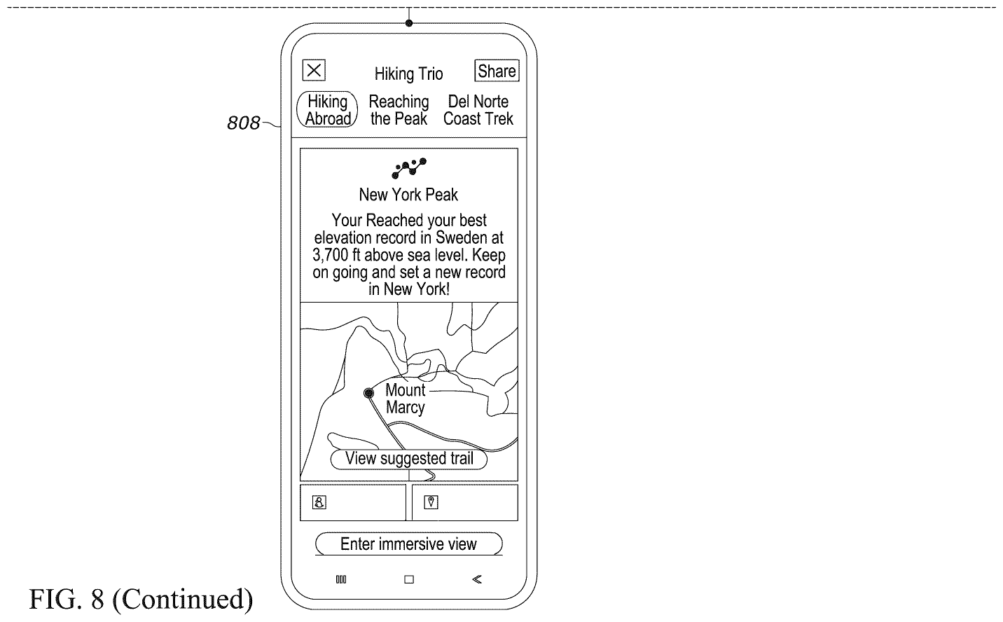

FIG. 8 illustrates an example set 800 of user interface displays and associated actions illustrating manners by which a meaningful memory may be surfaced to or accessed by the user of the electronic device in accordance with this disclosure. In the example set 800 of user interface displays and associated actions, paths into the memory stream generation 303 are illustrated. Here, these paths are represented in the example shown by a user search 801 (corresponding to FIG. 7A), user keyboard entry 802 (corresponding to FIG. 7B), and a user notification 803 (corresponding to FIG. 7C).

A detail view 804 of the meaningful memory surfaced may be accessed via any of the paths, which may not be limited to the three shown. The detail view 804 may include, for example, a key photo 805 from the meaningful memory content along with a title and brief description generated based on the content for the meaningful memory. The detail view 804 may also include user controls 806 for accessing different branches of the memory content generated based on different aspects of the content. In the example of FIG. 8, a set of meaningful memories relating to multiple hiking trips with the same group of hikers is surfaced and includes branches (accessed by user controls 806) for “Hiking Abroad,” “Reaching the Peak,” and “Del Norte Coase Trek.” Each of these may correspond to different excursions across different dates. Particular milestones or achievements associated with the surfaced memory (such as highest elevation reached) or objectives set by the user (such as future hikes) may also be displayed.

Through a user control associated with the key photo 805, for example, the user may access an immersive view 807 that allows zooming in and out of different branches of the surfaced memory. Other user controls (such as swiping up on the detail view 804) may allow the user to access display 808 of additional data associated with the surfaced memory or a branch thereof, such as location data for the most recent hiking excursion. Alternatively or in addition to location data, the memory stream generation 303 may aggregate relevant phone calls, video calls, photos, links, or other content made available to the user in the display 808 on the electronic device.

Although FIG. 8 illustrates one example of a set 800 of user interface displays and associated actions illustrating manners by which a meaningful memory may be surfaced to or accessed by the user of the electronic device, various changes may be made to FIG. 8. For example, different forms of user controls may be provided, and different aspects of the meaningful memory content (such as associated audio) may be used.

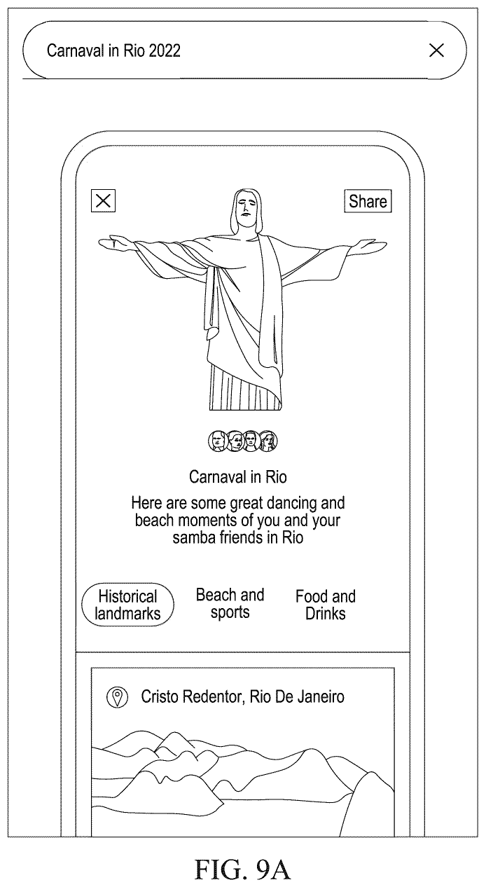

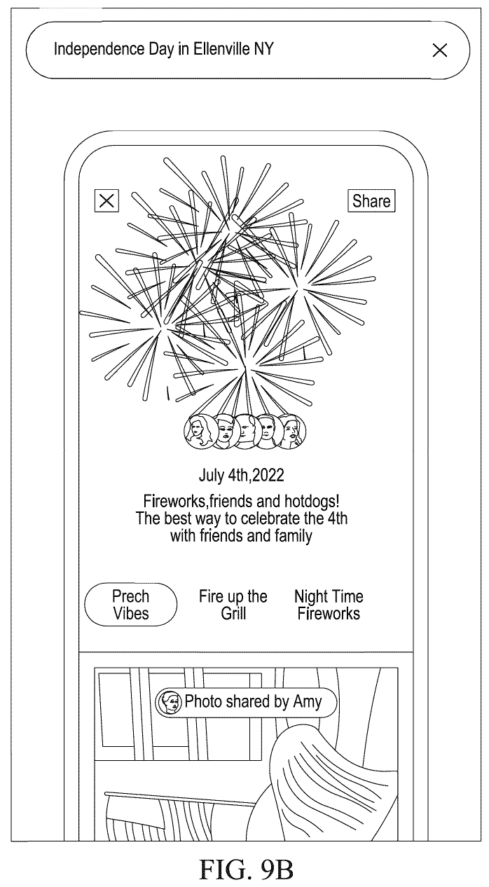

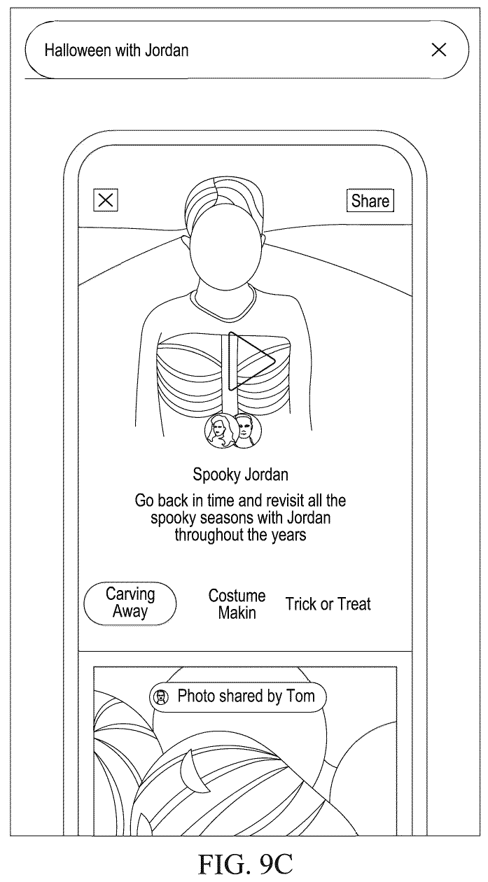

FIGS. 9A through 9C illustrate example user interface displays showing various examples of meaningful memories that can be aggregated and displayed by the memory stream using content locally stored on the user's electronic device in accordance with this disclosure. More specifically, FIG. 9A illustrates a surfaced memory relating to a vacation, while FIGS. 9B and 9C both relate to surfacing memories for a holiday (Independence Day and Halloween, respectively).

Although FIGS. 9A through 9C illustrate examples of user interface displays showing various examples of meaningful memories that can be aggregated and displayed by the memory stream using content locally stored on the user's electronic device, various changes may be made to FIGS. 9A through 9C. For example, the holiday-themed memories of FIGS. 9B and 9C may be aggregated, such as together with other holidays for the same year, or may be extended to the same holiday in different years.

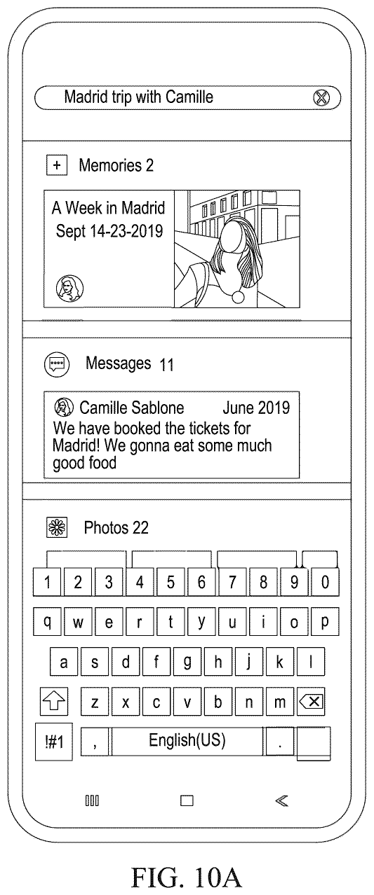

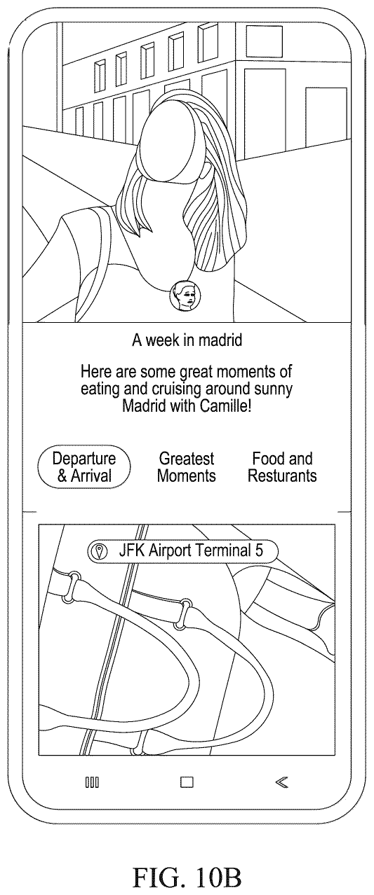

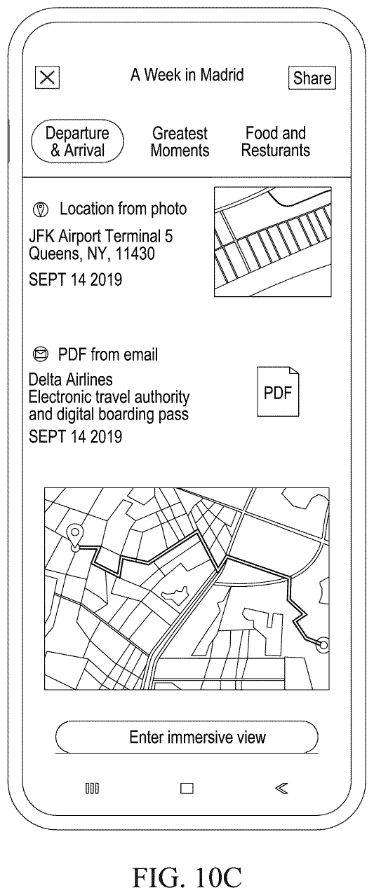

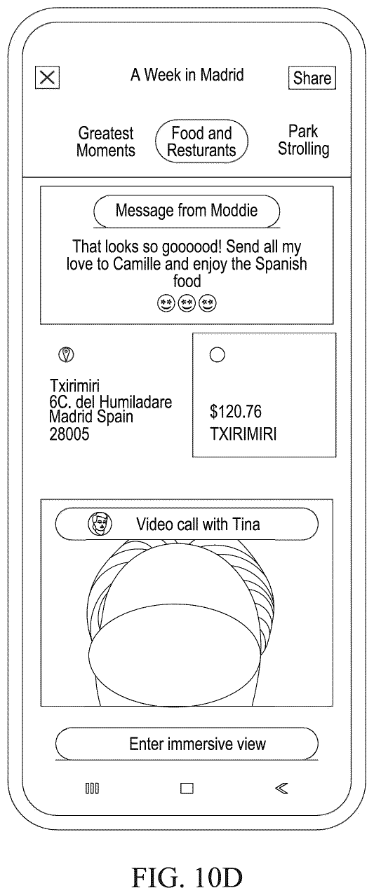

FIGS. 10A through 10D illustrate one example scenario for operation of the memory stream system 300 in accordance with this disclosure. In the scenario illustrated in FIGS. 10A through 10D, the memory stream generation 303 is accessed via a user search and displays a travel memory with a number of different types of contents.

In this example, FIG. 10A illustrates a user search in which one or more keywords (such as “Madrid” and “Camille”) are detected and employed to aggregate memory content. Once accessed based on the user search, the memory stream detail view is displayed as shown in FIG. 10B. Based on the aggregated content in the memory stream, a title (such as “A Week in Madrid”), memory description (such as “Here are some great moments of eating and cruising around sunny Madrid with Camille!”), and one or more branches (such as “Departure & Arrival,” “Greatest Moments,” “Food & Restaurant,” etc.) can be created. Each of the generated branches can group relevant aggregated content together. In the example of FIG. 10C, the “Departure & Arrival” branch displays the location from a photo taken at the beginning of the trip, together with a Madrid travel itinerary attachment from an email. The “Food & Restaurant” branch illustrated in FIG. 10D displays a message from a contact who reacted to a shared food photo taken in Madrid, the location of a restaurant where a payment took place, and a payment at the location identified as a restaurant.

Although FIGS. 10A through 10D illustrate one example of a scenario for operation of the memory stream system 300, various changes may be made to FIGS. 10A through 10D. For example, a key photo based on the location searched (such as “Madrid”) rather than the contact (such as “Camille”) may be employed for the detail view.

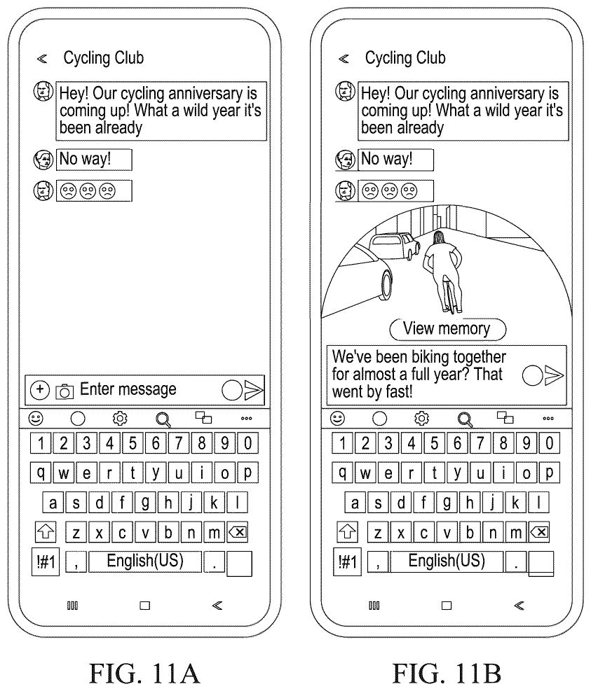

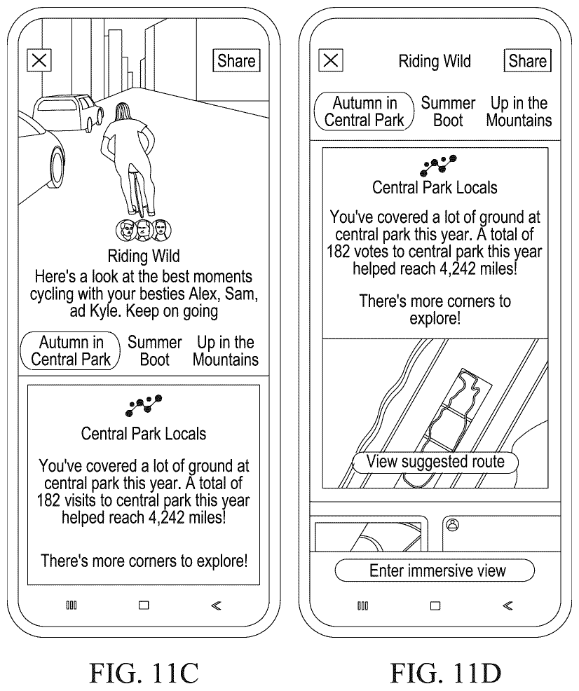

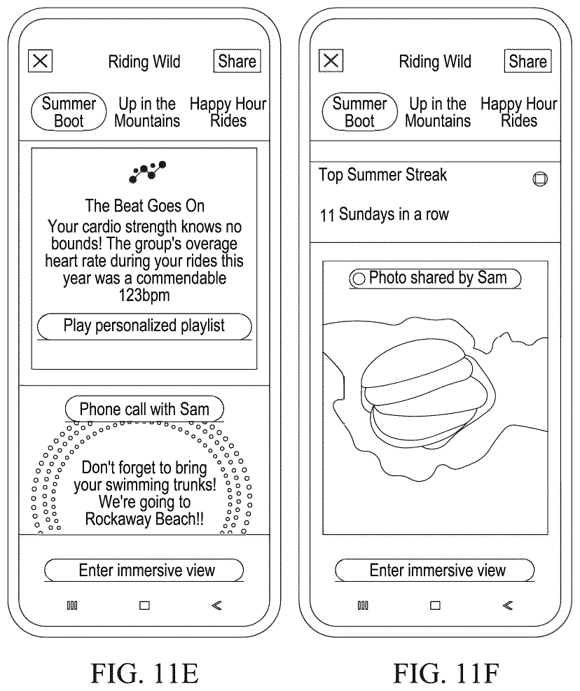

FIGS. 11A through 11F illustrate another example scenario for operation of the memory stream system 300 in accordance with this disclosure. In the scenario illustrated in FIGS. 11A through 11F, the memory stream generation 303 is accessed from a group chat and displays a memory related to the conversation.

In this example, FIG. 11A depicts a message composed in a group chat from which the memory stream system 300 detects one or more contacts, one or more timeframes, and one or more keywords to aggregate into a memory. In this example, this includes “cycling,” “anniversary,” and group participants. FIG. 11B depicts the memory stream system 300 displaying a link to memory content related to the event(s) referenced. When the user accesses the memory content, a memory stream detail view can be displayed as shown in FIG. 11C. Based on the aggregated content in the memory stream, a title (such as “Riding Wild”), memory description (such as “Here's a look at the best moments cycling with your besties Alex, Sam, and Kyle. Keep on going!), and one or more branches (such as “Autumn in Central Park,” “Summer Beat,” “Up in the Mountains,” etc.) can be created. The generated branches may span the identified timeframe (such as one year) and one or more groups (such as those including participants in the group chat) within the relevant aggregated content. In this example, the “Autumn in Central Park” branch (in FIG. 11D) displays the total visits to Central Park, cumulative distance, and a suggested route based on past routes in Central Park. In this example scenario, the “Summer Beat” branch displays a collective heart rate summary from a health app (FIG. 11E) along with a suggested personalized playlist, part of a transcribed relevant phone call from a contact in the cycling group, and (on a separate display shown in FIG. 11F) a photo received from the same contact.

Although FIGS. 11A through 11F illustrate another example of a scenario for operation of the memory stream system 300, various changes may be made to FIGS. 11A through 11F. For example, only group chat participants responding to the triggering message may be used in aggregated content for the memory stream generation 303 in order to avoid including individuals who no longer actively participate in that group.

The memory service described above provides an improved experience to users to re-live memories with increased detail (including details that may have been forgotten). The memory service also allows users to experience memories with more emotion. Further, the memory service provides resources to share with other parties, such as key details or information tied to a memory (like restaurant recommendations for a trip).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
associating, using at least one processing device of an electronic device, tags with content including two or more of: messages, links, files, call transcripts, payment transaction information, location history, contacts, or activity information in the electronic device;
determining, using the at least one processing device, connections between items of the content and connections of the items of the content with photos or videos in the electronic device;
identifying, using the at least one processing device, a memory as meaningful for a user of the electronic device based on at least some of the determined connections, wherein the memory is identified as meaningful based on at least one of:
one or more characteristics of a relationship between the user and a person corresponding to one of the contacts that is associated with the memory;
a frequency of communication between the user and the person;
content of the communication between the user and the person;
one or more characteristics of an event or an activity associated with the memory; and
one or more characteristics of a location associated with the memory;
aggregating, using the at least one processing device, digital content for the memory, the aggregated digital content including at least some of the tagged content associated with the memory and at least some of the photos or videos associated with the memory; and
creating, using the at least one processing device, a digital memory based on at least some of the aggregated digital content, the digital memory allowing the user to reexperience the memory, the digital memory including at least a portion of the tagged content within the aggregated digital content and at least a portion of the photos or videos within the aggregated digital content.

2. The method of claim 1, wherein the memory is identified as meaningful according to an estimation of emotional weight or significance of the memory to the user.

3. The method of claim 1, wherein the digital memory includes:
a representative photo or video associated with the memory;
a title and a description for the digital memory, each of the title and the description based on at least part of the aggregated digital content; and
one or more branches for different aspects of the digital memory.

4. The method of claim 3, wherein the different aspects of the digital memory include two or more of: timing, location, user activity, and one or more recommendations based on at least a portion of the aggregated digital content.

5. The method of claim 1, wherein the digital memory includes one or more additional photos or videos associated with the memory in addition to the representative photo or video.

6. The method of claim 1, wherein the digital memory is created in response to at least one of:
one or more keywords in a user search on the electronic device;
content in a message composed by the user on the electronic device; or
a current activity of the user.

7. The method of claim 1, further comprising:
generating a detail view for the digital memory;
generating one or more branches from the detail view for the digital memory; and
displaying an access link to the digital memory on the electronic device.

8. An electronic device comprising:
at least one processing device configured to:
associate tags with content including two or more of: messages, links, files, call transcripts, payment transaction information, location history, contacts, or activity information in the electronic device;
determine connections between items of the content and connections of the items of the content with photos or videos in the electronic device;
identify a memory as meaningful for a user of the electronic device based on at least some of the determined connections, wherein the at least one processing device is configured to identify the memory as meaningful based on at least one of:
one or more characteristics of a relationship between the user and a person corresponding to one of the contacts that is associated with the memory;
a frequency of communication between the user and the person;
content of the communication between the user and the person;
one or more characteristics of an event or an activity associated with the memory; and
one or more characteristics of a location associated with the memory;
aggregate digital content for the memory, the aggregated digital content including at least some of the tagged content associated with the memory and at least some of the photos or videos associated with the memory; and
create a digital memory based on at least some of the aggregated digital content, the digital memory allowing the user to reexperience the memory, the digital memory including at least a portion of the tagged content within the aggregated digital content and at least a portion of the photos or videos within the aggregated digital content.

9. The electronic device of claim 8, wherein the at least one processing device is configured to identify the memory as meaningful according to an estimation of emotional weight or significance of the memory to the user.

10. The electronic device of claim 8, wherein the digital memory includes:
a representative photo or video associated with the memory;
a title and a description for the digital memory, each of the title and the description based on at least part of the aggregated digital content; and
one or more branches for different aspects of the digital memory.

11. The electronic device of claim 10, wherein the different aspects of the digital memory include two or more of: timing, location, user activity, and one or more recommendations based on at least a portion of the aggregated digital content.

12. The electronic device of claim 8, wherein the digital memory includes one or more additional photos or videos associated with the memory in addition to the representative photo or video.

13. The electronic device of claim 12, wherein the at least one processing device is configured to create the digital memory in response to at least one of:
one or more keywords in a user search on the electronic device;
content in a message composed by the user on the electronic device; or
a current activity of the user.

14. The electronic device of claim 8, wherein the at least one processing device is further configured to:
generate a detail view for the digital memory;
generate one or more branches from the detail view for the digital memory; and
display an access link to the digital memory on the electronic device.

15. A non-transitory machine readable medium containing instructions that when executed cause at least one processing device of an electronic device to:
associate tags with content including two or more of: messages, links, files, call transcripts, payment transaction information, location history, contacts, or activity information in the electronic device;
determine connections between items of the content and connections of the items of the content with photos or videos in the electronic device;
identify a memory as meaningful for a user of the electronic device based on at least some of the determined connections, wherein the instructions when executed cause the at least one processor to identify the memory as meaningful based on at least one of:
one or more characteristics of a relationship between the user and a person corresponding to one of the contacts that is associated with the memory;
a frequency of communication between the user and the person;
content of the communication between the user and the person;
one or more characteristics of an event or an activity associated with the memory; and
one or more characteristics of a location associated with the memory;
aggregate digital content for the memory, the aggregated digital content including at least some of the tagged content associated with the memory and at least some of the photos or videos associated with the memory; and
create a digital memory based on at least some of the aggregated digital content, the digital memory allowing the user to reexperience the memory, the digital memory including at least a portion of the tagged content within the aggregated digital content and at least a portion of the photos or videos within the aggregated digital content.

16. The non-transitory machine readable medium of claim 15, wherein the instructions when executed cause the at least one processor to identify the memory as meaningful according to an estimation of emotional weight or significance of the memory to the user.

17. The non-transitory machine readable medium of claim 15, wherein the digital memory includes:
a representative photo or video associated with the memory;
a title and a description for the digital memory, each of the title and the description based on at least part of the aggregated digital content; and
one or more branches for different aspects of the digital memory.

18. The non-transitory machine readable medium of claim 17, wherein the different aspects of the digital memory include two or more of: timing, location, user activity, and one or more recommendations based on at least a portion of the aggregated digital content.

19. The non-transitory machine readable medium of claim 15, wherein the digital memory includes one or more additional photos or videos associated with the memory in addition to the representative photo or video.

20. The non-transitory machine readable medium of claim 15, wherein the instructions when executed cause the at least one processor to create the digital memory in response to at least one of:
one or more keywords in a user search on the electronic device;
content in a message composed by the user on the electronic device; or
a current activity of the user.
